(19) United States
(12) Patent Application Publication
(10) Pub. No.: US 2011/0120212 A1
(43) Pub. Date: May 26, 2011

(54) SYSTEM FOR DETERMINING A CONCENTRATION OF A SUBSTANCE IN A BODY FLUID

(75) Inventors: Hans Joergen Pedersen, Harrislee (DE); Kasper Mayntz Paasch, Soenderborg (DE); Holger Dirac, Birkeroed (DE)

(73) Assignee: P&V Consulting GmbH & Co. KG, Ludwigsburg (DE)

(21) Appl. No.: 12/935,349

(22) PCT Filed: Mar. 31, 2009
(86) PCT No.: PCT/DK09/00077

§ 371 Date: Feb. 9, 2011

(30) Foreign Application Priority Data
Mar. 31, 2008 (DK) PA 2008 00467

(51) Int. Cl. G01N 21/84

(52) U.S. Cl. 73/61.48

(57) ABSTRACT

A system (1) for optically determining a concentration of a substance of interest, e.g. glucose, in a body fluid. The system (1) comprises a probe head (2) adapted to be positioned in direct contact with a body fluid to be analysed, e.g. subcutaneously, in a blood vessel or in direct contact with a sample. The probe head (2) defines an analysis volume (5) which is at least partly delimited towards the body fluid by a semi-permeable membrane (6) allowing substances of interest to enter the analysis volume (5). The system (1) further comprises first light guiding means (7) arranged for guiding primary light (9) to the analysis volume (5), and second light guiding means (8) arranged for guiding secondary light (11) away from the analysis volume (5). The primary light (9) is scattered, preferably Raman scattered, and the scattered spectrum is used for determining the concentration of the substance of interest.

### CROSS REFERENCE TO RELATED APPLICATIONS

This application is entitled to the benefit of and incorporates by reference essential subject matter disclosed in International Patent Application No. PCT/DK2009/000077 filed on Mar. 31, 2009 and Danish Patent Application No. PA 2008 00467 filed on Mar. 31, 2008.

### FIELD OF THE INVENTION

The present invention relates to a system for determining a concentration of a substance of interest in a body fluid. The system of the present invention is, e.g., suitable for continuous determination of a concentration of a substance of interest which is present in a body fluid, e.g. a concentration of glucose in blood or interstitial fluid.

### BACKGROUND OF THE INVENTION

It is sometimes desirable to determine the presence and/or concentration of a particular substance of interest in a body fluid, e.g. for diagnostic purposes or in order to determine an amount of medical drug to be used for treating an already diagnosed disease or condition. For instance, persons having insulin-dependent diabetes need to know the level of glucose present in the blood in order to determine the required dose of insulin to be injected at a specific time. Accordingly, persons suffering from insulin-dependent diabetes have to measure the blood glucose level several times a day. This is normally done by puncturing the skin and a small blood vessel, pressing a small blood sample out of the resulting wound and feeding the sample to a blood glucose measuring device. Since it is inconvenient and sometimes painful to draw small blood samples in this manner, it is not uncommon that persons having insulin-dependent diabetes neglect to measure the blood glucose level as often as desired, and maybe completely fail to perform the measurements or only perform them once or twice a day. It is therefore desirable to provide methods for determining the blood glucose level which are more convenient and less painful than the conventional method described above.

To this end a number of attempts have been made to provide non-invasive optical methods for measuring blood glucose concentrations. Some of these are described in WO 2007/072300 and WO 2006/003551.

WO 2007/072300 discloses a system and method for non-invasive measurement of glucose concentration in a live subject including a thermal emission spectroscopy (TES) device, an optical coherence tomography (OCT) device or near infrared diffuse reflectance (NIDR) device. The TES generates a signal indicative of the absorption of glucose, from which the blood glucose concentration is determined and the OCT device generates a signal indicative of the scattering coefficient of a portion of the live subject, from which the blood glucose concentration is determined.

WO 2006/003551 discloses a spectroscopic system for non-invasive spectral analysis of substances or biological structures that are located in a plurality of various volumes of interest. The spectroscopic system makes use of a multiplicity of various probe heads that are connected to a base station providing a spectroscopic light source and spectroscopic analysis means.

The systems disclosed in WO 2007/072300 and WO 2006/003551 both suffer from the drawback that non-invasive optical measurements of concentrations of substances, such as blood glucose, are less accurate than invasive measurements, and thereby the accuracy of the measurements is sacrificed in order to make the measurement easier to perform by the user.

U.S. Pat. No. 7,277,740 discloses a system for reagent-free determination of the concentration of an analyte in vivo. The system comprises a light transmitter for generating monochromatic primary light, a scattered light percutaneous sensor which includes an inbound light guide and a detection light guide, a wavelength-selective detection device that is connected to the detection light guide for detection of Raman-scattered components of the secondary light and an evaluation device for determining the concentration of the analyte from the Raman-scattered components of the secondary light.

### SUMMARY OF THE INVENTION

It is an object of the invention to provide a system for determining a concentration of a substance of interest, the system being easy to operate.

It is a further object of the invention to provide a system for determining a concentration of a substance of interest, the system being capable of providing continuous in vivo measurements of the concentration of the substance of interest.

It is an even further object of the invention to provide a system for determining a concentration of a substance of interest, the system being capable of providing accurate measurements of the concentration of the substance of interest.

According to a first aspect of the invention the above and other objects are fulfilled by providing a system for determining a concentration of a substance of interest in a body fluid, the system comprising:

a probe head adapted to be positioned in direct contact with a body fluid to be analysed, said probe head defining an analysis volume, at least partly delimited towards the body fluid by a semi-permeable membrane allowing substances of interest from the body fluid to enter the analysis volume,
first light guiding means arranged for guiding primary light to the analysis volume, and
second light guiding means arranged for guiding secondary light away from the analysis volume.

The probe head is adapted to be positioned in direct contact with a body fluid to be analysed. Accordingly, the system of the invention is operated invasively in the sense that it is necessary to perform an invasive act in order to obtain a suitable sample of the body fluid to be analysed. This may be obtained by positioning the probe head invasively in direct contact with the body fluid. Alternatively, the sample may be obtained separately and subsequently be positioned in direct contact with the probe head. In the latter case the sample may be obtained by means of a separate apparatus and subsequently supplied to the system of the invention. Alternatively it may be collected by means of a catheter or the like which is connected directly to the system of the invention, in which case the sampling equipment and the system of the invention form part of the same apparatus, the system of the invention itself being arranged non-invasively.

The probe head defines an analysis volume which is at least partly delimited towards the body fluid by a semi-permeable membrane. In the present context the term ‘semi-permeable’ should be interpreted to mean that some substances are allowed to pass the membrane while other substances are not allowed to pass. Preferably, the membrane allows substances of interest, such as glucose, to pass, while other elements or constituents of the body fluid are substantially not allowed to pass. Accordingly, the substance of interest passes through the semi-permeable membrane and into the analysis volume, while other constituents of the body fluid are kept out of the analysis volume, and thereby analysis of the substance of interest can take place in the analysis volume in order to determine the concentration of the substance of interest.

It is an advantage that the probe head is arranged in direct contact with the body fluid to be analysed, since the concentration of the substance of interest is thereby determined on the basis of measurements performed directly on the body fluid, rather than on the basis of non-invasive optical measurement. Thereby a more precise measurement is obtained.

The system further comprises first light guiding means and second light guiding means. The first light guiding means is arranged for guiding primary light to the analysis volume, and the second light guiding means is arranged for guiding secondary light away from the analysis volume. The first light guiding means and the second light guiding means may be completely separated, e.g. in the form of two separate light guides, each guiding light to/from the analysis volume. Alternatively, the first and second light guiding means may be at least partly combined, e.g. in the form of a Y-shaped structure in which only one light guide enters the analysis volume, said light guide being used for guiding primary light into the analysis volume as well as for guiding secondary light away from the analysis volume. In this case the light guide is split outside the analysis volume into a first light guide for guiding primary light towards the combined part of the light guide and a second light guide for guiding secondary light away from the combined part of the light guide.

The system of the invention is preferably operated in the following manner. The probe head is arranged in contact with the body fluid, thereby allowing the substance of interest to enter the analysis volume via the semi-permeable membrane. Primary light is supplied to the analysis volume by means of the first light guiding means, thereby causing scattering, e.g. Raman scattering, on the molecules of the substance of interest present in the analysis volume. The secondary light produced in this manner is guided away from the analysis volume via the second light guiding means. Analysing the spectrum of the secondary light, e.g. the Raman spectrum, can then be used for determining the concentration of the substance of interest.

Thus, a system is provided which is adapted to provide precise determination of the concentration of a substance of interest. Furthermore, the system may easily be used in combination with a continuous sampling system, such as a catheter, and there is therefore no need to penetrate the skin each time it is necessary to perform a measurement.

The system may further comprise at least one laser, or another suitable light source being adapted to emit substantially monochromatic light, for emitting primary light, said laser(s) being connected to the first light guiding means. According to this embodiment the primary light is provided by means of at least one laser, and the laser(s) form(s) part of the system. The laser(s) may be permanently attached to an end of the first light guiding means which is arranged substantially opposite the analysis volume, or it/they may be connectable to the first light guiding means. Alternatively, a laser, or any other suitable primary light source, may be connected to the system without forming a part of the system. In this case the light source may be exchangeable and/or it may be selected by the user, e.g. to match a specific need, such as analysis of a specific substance of interest.

In the case that the system comprises at least one laser, at least one of the laser(s) may be a pulsed laser. The pulsed laser may advantageously be adapted to emit pulses having a duration which is shorter than 1 ps, such as shorter than 100 fs, such as in the femtosecond range. It is an advantage to use a pulsed laser which is adapted to emit pulses having a very short duration for the following reason. The shorter the duration of a laser pulse is, the broader a wavelength range is covered by the laser pulse. Thus, using a pulsed laser having a sufficiently short duration provides a wavelength profile which is sufficiently broad to at least substantially cover the entire Raman spectrum of the substance of interest. Thereby it is not necessary to scan the wavelengths or tune the input light source in order to obtain the Raman spectrum.

Alternatively or additionally, at least one of the laser(s) may be a continuous wave (cw) laser. According to this embodiment a cw laser may be used as a pump laser for enhancing population of Raman levels of molecules of a substance of interest. Thereby the signal used for determining the concentration of the substance of interest is enhanced, and the signal to noise ratio is improved. Thereby a more reliable determination of the concentration of the substance of interest is obtained. According to this embodiment the concentration of the substance of interest may be determined using coherent anti-Stokes Raman spectroscopy (CARS).

The probe head may be adapted to be positioned invasively, such as subcutaneously or in a blood vessel, e.g. intravenously or intra-arterially. It is an advantage that the probe head is adapted to be positioned invasively, since the probe head is in this case arranged close to the sampling position. Thereby the response time of the system can be minimised.

In the case that the probe head is adapted to be positioned subcutaneously, the body fluid may advantageously be interstitial fluid, and in the case that the probe head is adapted to be positioned in a blood vessel, the body fluid may advantageously be blood.

The system may further comprise detection means adapted to detect Raman scattered light, said detection means being connected to the second light guiding means. According to this embodiment the detection means used for detecting, and possibly analysing, the Raman scattered light forms part of the system.

The system may further comprise at least one reflective surface arranged in an interior part of the analysis volume. According to this embodiment the primary light entering the analysis volume is reflected from the reflective surface. Thereby it travels a distance inside the analysis volume which is approximately twice as long as the distance travelled in the case that no reflective surface was present. Thereby the probability that the primary light is scattered from a molecule of the substance of interest is increased, and an enhanced signal can be obtained.

At least one of the reflective surface(s) may be provided with a structured metal surface, e.g. a microstructured metal surface. The structured metal surface is preferably of a kind which is suitable for adsorption of molecules of the substance of interest. In this case an enhanced Raman signal can be obtained by means of Surface Enhanced Raman Spectroscopy (SERS). Thereby it is possible to detect the presence of substances of interest even at very low concentrations.

The structured metal surface may advantageously be made from a precious metal, such as gold, silver, copper or platinum.

The semi-permeable membrane may be arranged in a wall part of the probe head, preferably arranged at a distance from an end part of the probe head. According to this embodiment an end part of the probe head is not covered by the semi-permeable membrane.

The first and/or the second light guiding means may comprise an optical fibre. Alternatively or additionally, the first and/or the second light guiding means may be or comprise any other suitable means for guiding an appropriate kind of primary/secondary light to/from the analysis volume.

The substance of interest may be glucose. In this case the system of the invention may advantageously be used for measuring the blood glucose level, e.g. in order to determine an amount of drug, e.g. insulin, to be administered to a person, e.g. a person having insulin-dependent diabetes.

The body fluid is blood, interstitial fluid, or any other suitable body fluid containing the substance of interest.

The system may further comprise a metal microstructure arranged in the analysis volume of the probe head. The metal microstructure may, e.g., be in the form of small objects, e.g. nanoparticles, which have been applied to the interior of the analysis volume. The metal microstructures are preferably of a kind which is suitable for adsorption of molecules of the substance of interest. In this case some of the molecules of the substance of interest being present in the body fluid entering the analysis volume are adsorbed by the metal microstructures, and the Raman signal originating from these molecules is enhanced significantly, since they give rise to a Surface Enhanced Raman Spectroscopy (SERS) effect. Thereby it is possible to detect the presence of substances of interest, even at very low concentrations.

The metal microstructures may be or comprise precious metals, such as gold, silver, copper or platinum.

The semi-permeable membrane may form part of the first light guiding means and/or the second light guiding means. This embodiment may advantageously be realised by providing a hollow fibre made from a semi-permeable material, the hollow fibre thereby constituting the semi-permeable membrane. An optical core may then be positioned in the interior of the hollow fibre in such a manner that a space is defined between the optical core and the semi-permeable membrane. This space may contain air or a suitable liquid, e.g. a saline solution. By selecting the material of the optical core in such a manner that the optical core has a higher index of refraction than the material contained in the space defined between the optical core and the semi-permeable membrane, the optical core, the hollow fibre and the material arranged between the optical core and the semi-permeable membrane in combination form an optical wave guide.

According to a second aspect of the invention the above and other objects are fulfilled by providing a system for determining a concentration of a substance of interest in a body fluid, the system comprising:

an analysis part adapted to be positioned in direct contact with a body fluid to be analysed, said analysis part defining an analysis volume,

first light guiding means arranged for guiding primary light to the analysis volume, and

second light guiding means arranged for guiding secondary light away from the analysis volume,

wherein the analysis volume is provided with a metal microstructure adapted to adsorb molecules of the substance of interest.

It should be noted that a person skilled in the art would readily recognise that any feature described in combination with the first aspect of the invention could also be combined with the second aspect of the invention, and vice versa.

The analysis part is the part of the system which is arranged in direct contact with the body fluid to be analysed during operation of the system. The analysis part could be a probe head as described above with reference to the first aspect of the invention, but it could alternatively be a part of the system which does not form a head or an end part. For instance, the analysis part could be a part arranged on the middle of an optical fibre. The analysis volume is defined by the analysis part, preferably forming a part of the analysis part.

The analysis volume is provided with a metal microstructure adapted to adsorb molecules of the substance of interest. Accordingly, when the analysis part is arranged in contact with the body fluid to be analysed, molecules of the substance of interest enter the analysis volume. Some of the molecules are then adsorbed by the metal microstructure. When primary light is guided to the analysis volume via the first light guiding means the primary light is scattered on the adsorbed molecules and the secondary, scattered light is guided away from the analysis volume via the second light guiding means. The scattered light is then analysed in order to determine the concentration of the substance of interest in the body fluid. Since the primary light was scattered from the adsorbed molecules, this analysis may be performed using Surface Enhanced Raman Spectroscopy (SERS) as previously described. Thereby a relatively strong signal is obtained, allowing very small concentrations of the substance of interest to be detected.

The system may further comprise a semi-permeable membrane arranged to at least partly delimit the analysis volume towards the body fluid to be analysed. As described above, such a semi-permeable membrane allows molecules of the substance of interest to pass and enter the analysis volume, but prevents larger molecules, which may cause large background signals, from entering the analysis volume. In some situations this enhances the signal-to-noise ratio. However, as an alternative, the metal microstructure may be arranged in direct contact with the body fluid to be analysed, without a semi-permeable membrane there between. This will be described further below.

The metal microstructure may be arranged at an end part of the first light guiding means and/or the second light guiding means. According to this embodiment the first and/or the second light guiding means may advantageously be an optical fibre having the metal microstructure mounted directly on an end part thereof. In this case the metal microstructure may be a metal monolayer grown directly on the end part of the light guiding means. Alternatively, the metal microstructure may be somewhat thicker.

The metal microstructure may be formed in a number of various manners. As mentioned above, it may be a monolayer grown directly on an end part of a light guiding means. Alternatively, it may be in the form of nano-particles applied to an interior part of the analysis volume. As another alternative, the metal microstructure may be applied directly onto an end part of a light guiding means, e.g. by means of sputtering, chemical vapour deposition (CVD) or another suitable technique. As yet another alternative it may be a patterned metal layer applied to an end part of a light guiding means, e.g. using a masking technique or a photolithographic technique. Finally, it may be a semitransparent metal layer applied to an end part of a light guiding means using a suitable technique.

As an alternative to arranging the metal microstructure at an end part of the first and/or the second light guiding means, the metal microstructure may be arranged between the first light guiding means and the second light guiding means. According to this embodiment, primary light is guided to one part of the metal microstructure via the first light guiding means, and secondary light is guided away from another, oppositely arranged, part of the metal microstructure via the second light guiding means.

The first light guiding means and the second light guiding means may form part of the same optical fibre. According to this embodiment the primary light and the secondary light may be guided by the same optical fibre. Alternatively, the analysis part may be arranged at a middle part of the optical fibre. In this case the primary light is guided to the analysis volume via a first part of the optical fibre, and the secondary light is guided away from the analysis volume via a second part of the optical fibre.

The system may further comprise at least one reflective surface arranged in an interior part or adjacent to the analysis volume. As described above, the primary light is thereby caused to pass through the analysis volume twice, thereby increasing the probability of the primary light being scattered on a molecule of the substance of interest.

The analysis volume may be formed by the metal microstructure. According to this embodiment the metal microstructure is arranged in direct contact with the body fluid to be analysed. In the case that the analysis part is to be positioned invasively, the metal microstructure should preferably be made from a biocompatible material, i.e. a material which is compatible with the kind of tissue in which it is intended to arrange the analysis part.

### BRIEF DESCRIPTION OF THE DRAWINGS

The invention will now be described in further detail with reference to the accompanying drawings in which

FIG. 1 is a schematic view of a system according to a first embodiment of the invention,

FIG. 2 is a schematic view of a system according to a second embodiment of the invention,

FIG. 3 is a schematic view of a system according to a third embodiment of the invention,

FIG. 4 shows a first example of a probe head for use in a system according to the invention,

FIG. 5 shows a second example of a probe head for use in a system according to the invention,

FIG. 6 shows a third example of a probe head for use in a system according to the invention,

FIG. 7 shows a fourth example of a probe head for use in a system according to the invention,

FIG. 8 is a schematic view of a system according to a fourth embodiment of the invention,

FIG. 9 is a schematic view of a system according to a fifth embodiment of the invention,

FIG. 10 is a schematic view of a system according to a sixth embodiment of the invention,

FIG. 11 is a schematic view of a system according to a seventh embodiment of the invention,

FIG. 12 is a schematic view of a system according to an eighth embodiment of the invention,

FIG. 13 is a schematic view of a system according to a ninth embodiment of the invention, and

FIG. 14 is a schematic view of a system according to a tenth embodiment of the invention.

### DETAILED DESCRIPTION

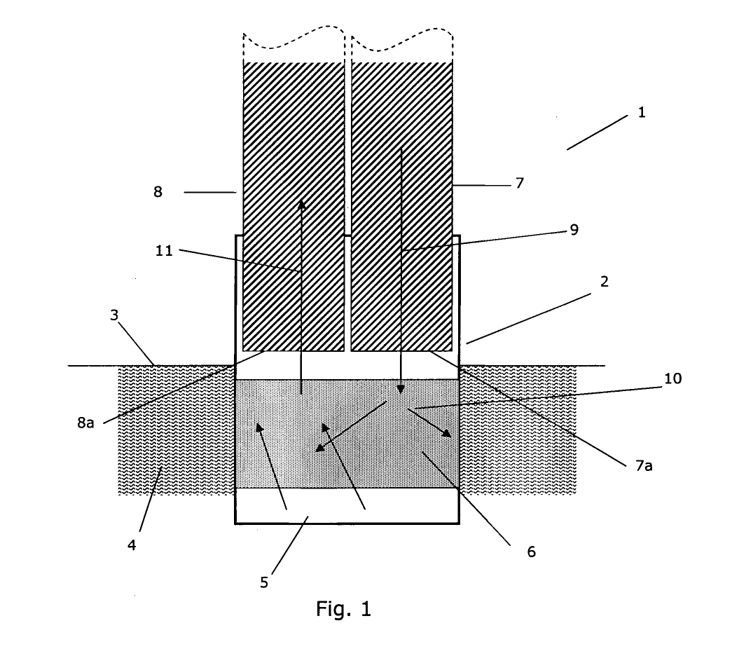

FIG. 1 is a schematic view of a system 1 according to a first embodiment of the invention. The system 1 comprises a probe head 2 arranged partly subcutaneously, i.e. below a skin surface 3. Thereby the probe head 2 is arranged in direct contact with tissue 4 comprising interstitial fluid present in this region. It should be noted that the probe head 2 could, alternatively, be arranged in a blood vessel or in contact with a suitable body fluid being sampled separately, e.g. via a catheter.

Inside the probe head 2 an analysis volume 5 is defined. The analysis volume 5 is partly delimited towards the interstitial fluid by a semi-permeable membrane 6. The semi-permeable membrane 6 allows substances of interest, such as glucose, to pass, while other constituents of the body fluid are not allowed to pass the semi-permeable membrane 6. Accordingly, molecules of a particular substance of interest are present in the analysis volume 5.

The system 1 further comprises a first light guide 7 and a second light guide 8, both having an end 7a, 8a arranged in the analysis volume 5. The first light guide 7 is arranged for guiding primary light 9 to the analysis volume 5. In the analysis volume 5 the primary light 9 is scattered from molecules of the substance of interest, e.g. due to Raman scattering, thereby producing secondary light in the form of scattered light 10. The second light guide 8 is arranged for guiding secondary light 11 away from the analysis volume and towards a detection unit and/or an analysis unit, in which the secondary, scattered light 11 is detected and/or analysed and used as a basis for determining the concentration of the substance of interest in the body fluid being analysed.

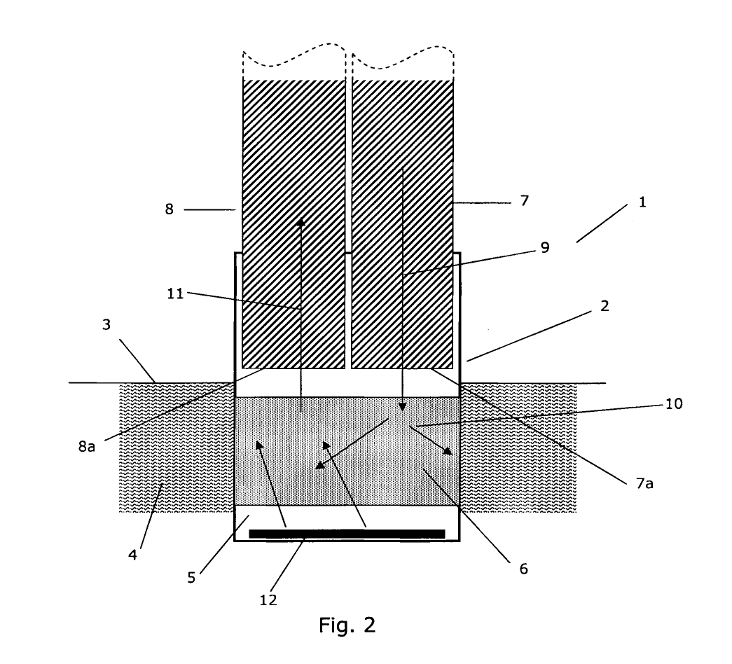

FIG. 2 is a schematic view of a system 1 according to a second embodiment of the invention. The system in FIG. 2 is very similar to the system of FIG. 1, and the operation of the system 1 will therefore not be described in detail here. The system of FIG. 2 further comprises a reflective surface 12 arranged in the analysis volume 5 opposite to the position of the ends 7a, 8a of the light guides 7, 8. Accordingly, primary light 9 entering the analysis volume 5 via the first light guide 7, and which is not scattered immediately, is reflected from the reflective surface 12. Thereby the primary light 9 travels the distance of the analysis volume 5 once again, and the probability of a given photon being scattered by a molecule of the substance of interest is thereby doubled. Thereby an enhanced signal is obtained.

As described above, the reflective surface 12 may be provided with a structured metal surface. In this case molecules of the substance of interest may be adsorbed at the structured metal surface, and thereby Surface Enhanced Raman Spectroscopy (SERS) may be used for obtaining a Raman signal which is enhanced by several orders of magnitude. This allows substances of interest to be detected, even at very low concentrations.

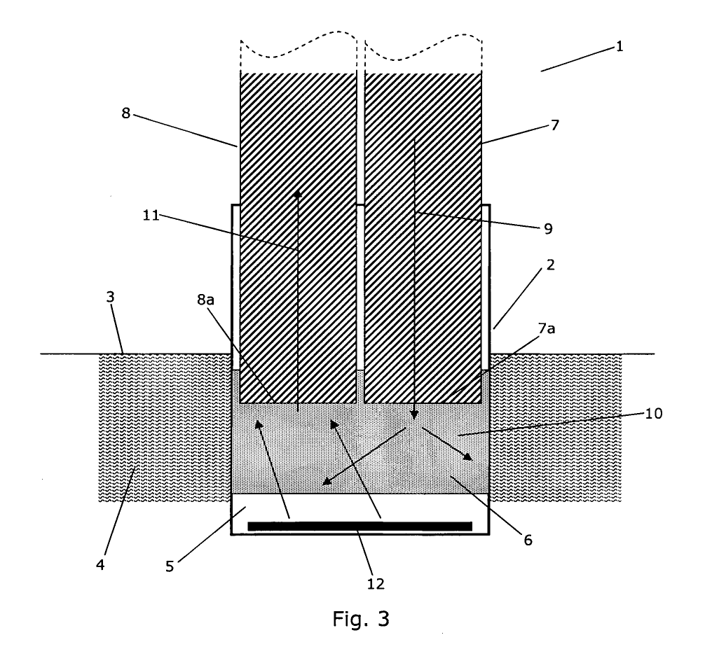

FIG. 3 is a schematic view of a system 1 according to a third embodiment of the invention. The system 1 of FIG. 3 is very similar to the system 1 of FIG. 2. However, in the embodiment of FIG. 3 the ends 7a, 8a of the light guides 7, 8 are arranged at a position corresponding to the position of the semi-permeable membrane 6, and below the skin surface 3.

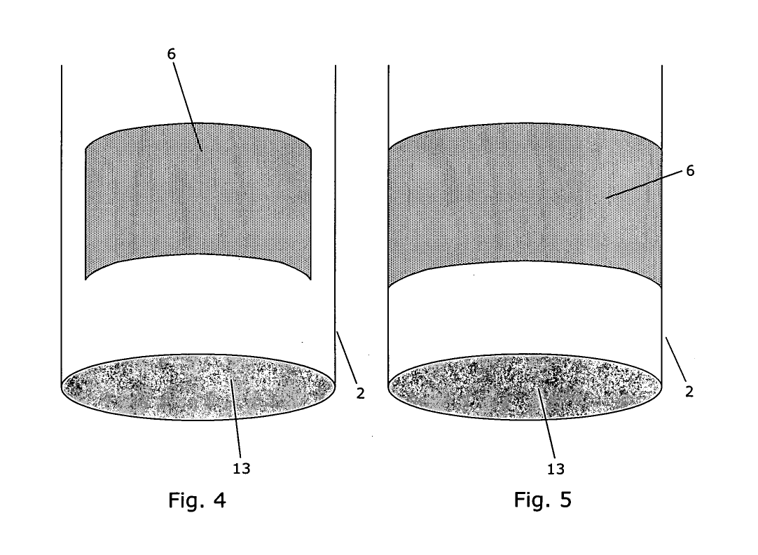

FIGS. 4-7 show probe heads 2 for use in a system according to the invention, with the semi-permeable membrane 6 arranged in various manners.

In FIG. 4 the semi-permeable membrane 6 is arranged at a distance from an end part 13 of the probe head 2, and as a ‘window’ formed in the probe head 2.

In FIG. 5 the semi-permeable membrane 6 is also arranged at a distance from the end part 13 of the probe head 2. However, in this case the semi-permeable membrane 6 extends the entire circumference of the probe head 2.

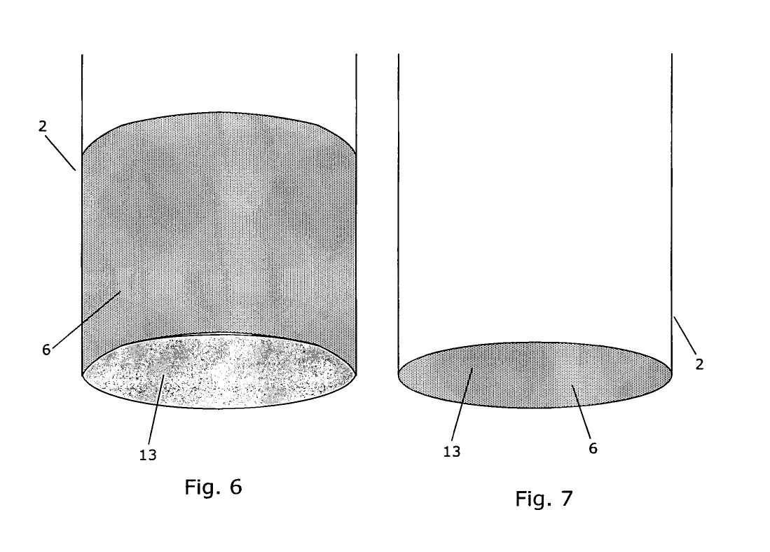

In FIG. 6 the semi-permeable membrane 6 extends the entire circumference of the probe head 2, and it extends to the end part 13, but not across the end part 13.

In FIG. 7 the semi-permeable membrane 6 forms the end part 13 of the probe head 2, but it is not arranged at the side walls of the probe head 2.

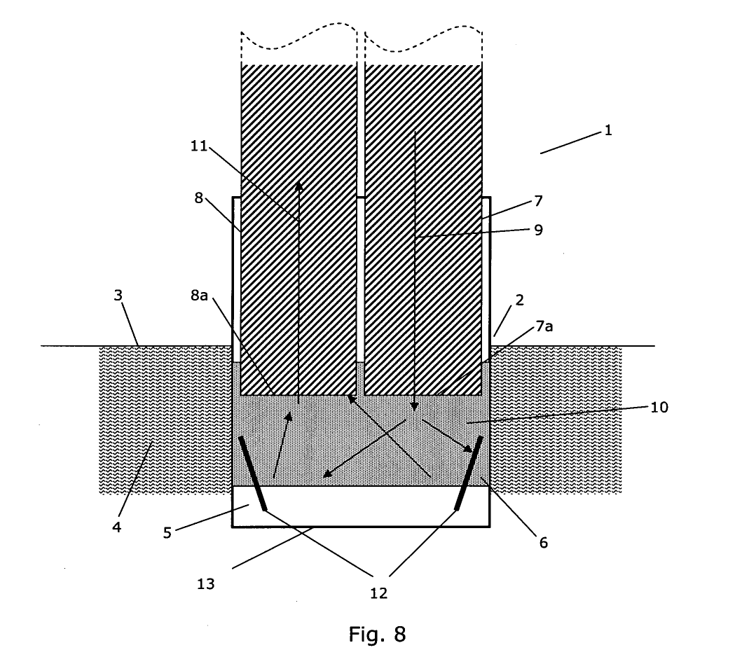

FIG. 8 is a schematic view of a system 1 according to a fourth embodiment of the invention. The system 1 of FIG. 8 is very similar to the system of FIG. 3. However, in this the reflective surface 12 is arranged in the analysis volume 5 at an angle to the end part 13 of the probe head 2. The reflective surface 12 may be in the form of a plurality of surfaces, or it may be a single surface having a substantially cylindrical shape.

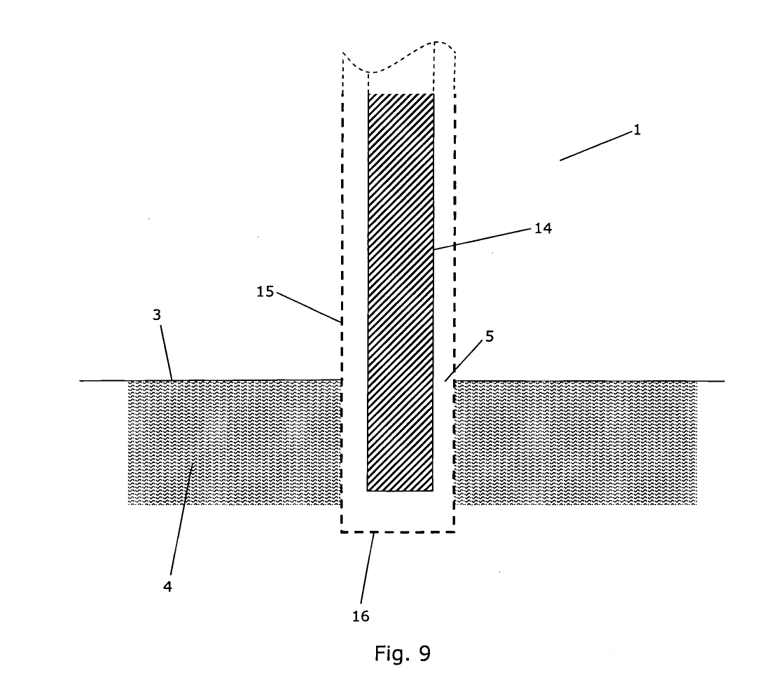

FIG. 9 is a schematic view of a system 1 according to a fifth embodiment of the invention. The system 1 of FIG. 9 comprises a light guide in the form of an optical core 14 arranged inside a hollow fibre 15 made from a semi-permeable material. An end part 16 of the hollow fibre 15 is arranged beneath the skin surface 3, and the semi-permeable membrane material of the hollow fibre 15 is thereby in direct contact with the tissue 4. Accordingly, molecules of a substance of interest, e.g. glucose, are thereby allowed to enter a space defined between the optical core 14 and the hollow fibre 15. This space thereby constitutes an analysis volume 5.

Furthermore, the analysis volume 5, delimited by the semi-permeable hollow fibre 15, forms a region having a lower index of refraction than the optical core 14. Thereby the analysis volume 5 may act as a cladding layer. In this case the optical core 14 and the analysis volume 5 in combination form a concentric optical waveguide which can be used for guiding primary light towards the end part 16 as well as for guiding secondary light away from the end part 16. Primary light arriving at the analysis volume 5 is scattered, e.g. Raman scattered, on molecules of the substance of interest. The scattered light is guided away from the analysis volume and towards a detection and/or analysis apparatus via the waveguide formed by the optical core 14 and the analysis volume 5. This is similar to the embodiments described above.

The system 1 shown in FIG. 9 has the advantage that the region where primary light can be scattered on molecules of the substance of interest is relatively large. Thereby a larger signal can be obtained, and it is possible to detect smaller concentrations of the substance of interest.

The analysis volume 5, in particular the part arranged near the end part 16, may be provided with a metal microstructure, e.g. in the form of nano-particles arranged in the interior of the analysis volume 5. In this case molecules of the substance of interest may be adsorbed on the surface of the metal microstructure. When the primary light reaches the analysis volume 5 it will scatter on the adsorbed molecules of the substance of interest, and the concentration of the substance of interest can be determined using Surface Enhanced Raman Spectroscopy (SERS) as previously described. Thereby a stronger signal can be obtained, and it is possible to detect smaller concentrations of the substance of interest.

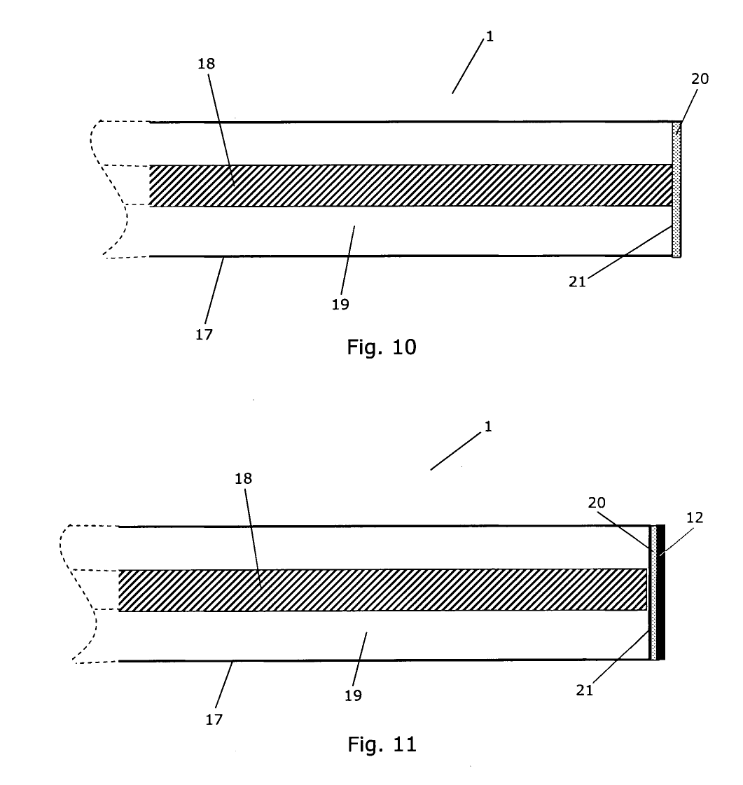

FIG. 10 is a schematic view of a system 1 according to a sixth embodiment of the invention. The system 1 of FIG. 10 comprises an optical fibre 17 comprising a core 18 and a cladding layer 19. A metal microstructure 20 is attached at an end part 21 of the optical fibre 17. The metal microstructure 20 may be a monolayer of a suitable metal, or it may be a somewhat thicker layer. The metal microstructure 20 may be a patterned layer of metal, e.g. applied by means of a photolithographic technique, or it may be a layer applied by means of sputtering, chemical vapour deposition (CVD) or another suitable technique. Alternatively or additionally, it may be a semitransparent layer of a suitable metal and/or a layer of nano-particles. The metal microstructure 20 is preferably relatively porous, thereby defining a large surface.

The system of FIG. 10 is preferably operated in the following manner. At least the end part 21 of the optical fibre 17 along with the metal microstructure 20 is positioned in contact with a body fluid to be analysed. The system may be arranged invasively, e.g. subcutaneously as in the previously described embodiments, or it may be arranged in contact with a previously obtained sample. Thus, the metal microstructure 20 is arranged in direct contact with the body fluid, and thereby with molecules of the substance of interest. Thereby molecules of the substance of interest are adsorbed on the surface of the metal microstructure.

Primary light is guided by means of the optical fibre 17 to the metal microstructure 20. Here it is scattered, preferably Raman scattered, on the molecules of the substance of interest which have been adsorbed on the surface of the metal microstructure 20. The scattered light is guided away from the metal microstructure 20 and towards a detection and/or analysis unit by means of the optical fibre 17. Here the concentration of the substance of interest is determined. Since the primary light was scattered on molecules of the substance of interest which were adsorbed on the metal microstructure, this determination can be made using Surface Enhanced Raman Spectroscopy (SERS). As described above, a stronger signal can thereby be obtained, allowing smaller concentrations of the substance of interest to be detected.

FIG. 11 is a schematic view of a system 1 according to a seventh embodiment of the invention. The system 1 of FIG. 11 is very similar to the system 1 of FIG. 10, and it will therefore not be described in further detail here. However, the system 1 of FIG. 11 comprises a reflective surface 12 arranged adjacent to the metal microstructure 20. Accordingly, the part of the primary light which passes through the metal microstructure 20 without being scattered on the molecules of the substance of interest which are adsorbed on the metal microstructure 20 will be reflected by the reflective surface 12. The reflected light will thereby travel through the metal microstructure 20 once more. Thereby the probability that the light is scattered on an adsorbed molecule of the substance of interest is increased substantially by a factor 2. Accordingly, an even stronger signal is obtained, allowing even smaller concentrations of the substance of interest to be detected.

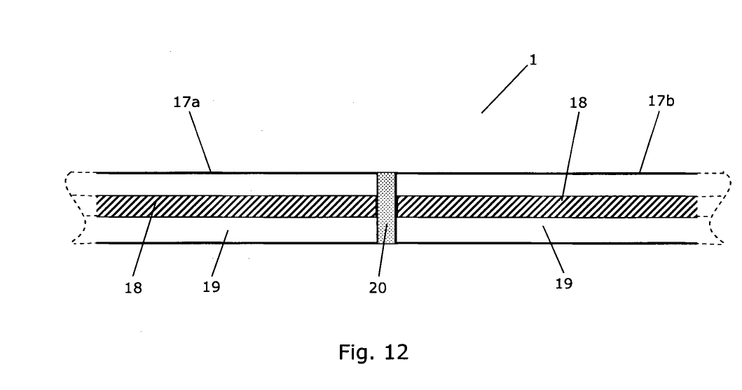

FIG. 12 is a schematic view of a system 1 according to an eighth embodiment of the invention. The system 1 of FIG. 12 is similar to the system 1 shown in FIG. 10. In FIG. 12 part of the optical fibre 12 has been removed and a metal microstructure 20 has been arranged at the position where material has been removed. It should be noted that all of the fibre material at this position could be removed, in which case only the metal microstructure 20 keeps the two parts 17a, 17b of the optical fibre 17 together. Alternatively, only part of the fibre material may be removed, e.g. one or more segments of the optical fibre 17, or only the cladding material 19, leaving the core 18.

The system 1 of FIG. 12 is preferably operated in the following manner. The part of the optical fibre 17 where the metal microstructure 20 is positioned is arranged in contact with a body fluid to be analysed. The optical fibre 17 may be arranged invasively, e.g. subcutaneously as described above, or it may be arranged in contact with a previously obtained sample. In the case that the optical fibre 17 is arranged invasively it could be envisaged that the skin surface is penetrated in two positions, a first part 17a of the optical fibre 17 protruding through one of the penetrations and a second part 17b of the optical fibre 17 protruding through the other penetration, thereby positioning the metal microstructure 20 invasively and in contact with the body fluid and thereby in contact with the substance of interest.

Molecules of the substance of interest will then be adsorbed on the metal microstructure 20 as described above, and the metal microstructure 20 defines an analysis volume.

Primary light is guided towards the metal microstructure 20 via the first part 17a of the optical fibre 17. Some of the primary light is scattered on the adsorbed molecules of the substance of interest, and the scattered light is guided away from the metal microstructure 20 via the second part 17b of the optical fibre 17. The scattered light is analysed using Surface Enhanced Raman Spectroscopy (SERS) as described above.

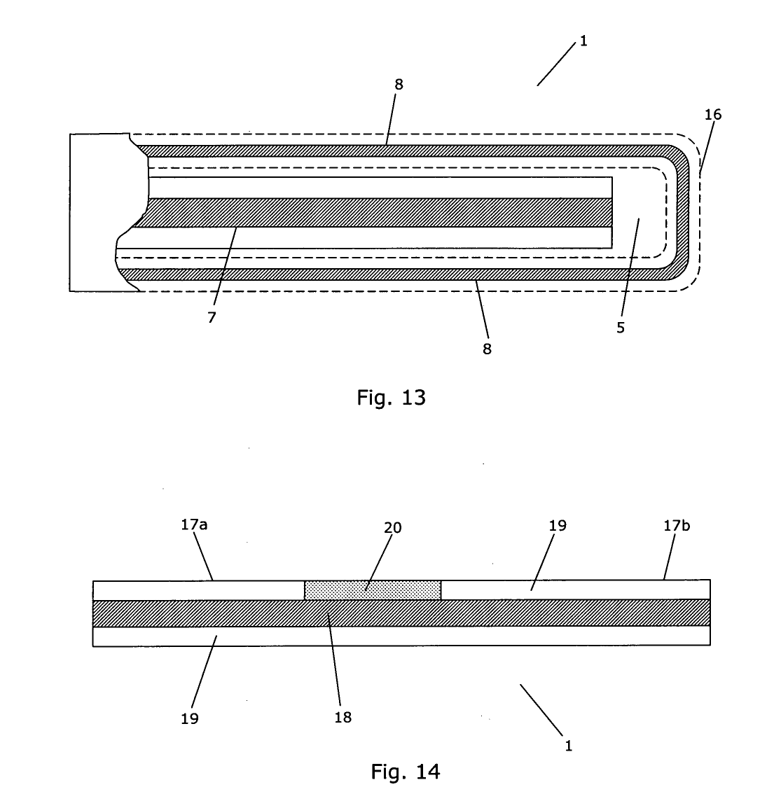

FIG. 13 is a schematic view of a system 1 according to a ninth embodiment of the invention. The system 1 of FIG. 13 is similar to the system 1 shown in FIG. 9. The system 1 of FIG. 13 comprises a first light guide 7 arranged to guide primary light towards an analysis volume 5 and a second light guide 8 arranged to guide secondary light away from the analysis volume 5. The second light guide 8 is made from a semi-permeable material, i.e. molecules of the substance of interest are allowed to pass through the second light guide 8 and into the analysis volume 5.

The system 1 of FIG. 13 is preferably operated in the following manner. The end part 16 of the system 1 is arranged in contact with a body fluid to be analysed. Thereby molecules of the substance of interest are allowed to enter the analysis volume 5 through the second light guide 8 as described above. Primary light is then guided to the analysis volume 5 via the first light guide 7. In the analysis volume 5 the primary light is scattered, preferably Raman scattered, on molecules of the substance of interest, and the scattered, secondary light is guided away from the analysis volume 5 via the second light guide 8.

FIG. 14 is a schematic view of a system 1 according to a tenth embodiment of the invention. The system 1 of FIG. 14 is similar to the system shown in FIG. 12. In the system 1 of FIG. 14 only part of the cladding layer 19 has been removed and a metal microstructure 20 has been arranged at this position. The metal microstructure 20 forms an analysis volume, and the system 1 is operated as the described above with reference to FIG. 12.

While the present invention has been illustrated and described with respect to a particular embodiment thereof, it should be appreciated by those of ordinary skill in the art that various modifications to this invention may be made without departing from the spirit and scope of the present.

What is claimed is:

1-27. (canceled)

28. A system for determining a concentration of a substance of interest in a body fluid, the system comprising:
a probe head adapted to be positioned in direct contact with a body fluid to be analysed, said probe head defining an analysis volume, at least partly delimited towards the body fluid by a semi-permeable membrane allowing substances of interest from the body fluid to enter the analysis volume,
first light guiding means arranged for guiding primary light to the analysis volume, and
second light guiding means arranged for guiding secondary light away from the analysis volume,
wherein it further comprises at least one reflective surface arranged in an interior part of the analysis volume opposite to the position of the ends of the first and second light guiding means.

29. The system according to claim 28, wherein the reflective surface is arranged in the analysis volume at an angle to the end part of the probe head.

30. The system according to claim 28, wherein the reflective surface is in the form of a plurality of surfaces.

31. The system according to claim 28, wherein the reflective surface has a substantially cylindrical shape.

32. The system according to claim 28, wherein at least one of the reflective surface(s) is provided with a structured metal surface.

33. The system according to claim 28, wherein the probe head is adapted to be positioned invasively.

34. The system according to claim 33, wherein the probe head is adapted to be positioned subcutaneously.

35. The system according to claim 33, wherein the probe head is adapted to be positioned in a blood vessel.

36. The system according to claim 28, wherein the semi-permeable membrane is arranged in a wall part of the probe head.

37. The system according to claim 28, wherein the semi-permeable membrane is arranged at a distance from an end part of the probe head.

38. The system according to claim 28, wherein the first and/or the second light guiding means comprise(s) an optical fibre.

39. The system according to claim 28, further comprising a metal microstructure arranged in the analysis volume of the probe head.

40. The system according to claim 28, wherein the semi-permeable membrane forms part of the first light guiding means and/or the second light guiding means.
